(19) United States
(12) Patent Application Publication
(10) Pub. No.: US 2017/0129063 A1
(43) Pub. Date: May 11, 2017

(54) MACHINE TOOL SYSTEM AND METHOD FOR OPERATING A MACHINE TOOL SYSTEM

(71) Applicant: MAG IAS GmbH, Eislingen (DE)

(72) Inventors: Hubert Bruder, Oberkirch (DE); Ralf Haug, Deggingen (DE)

(21) Appl. No.: 15/332,046

(22) Filed: Oct. 24, 2016

Related U.S. Application Data
(63) Continuation of application No. PCT/EP2015/059817, filed on May 5, 2015.

(30) Foreign Application Priority Data
May 9, 2014 (DE) 10 2014 106 572

(51) Int. Cl. B23Q 7/04; B23Q 3/00; B23Q 16/00

(52) U.S. Cl. CPC B23Q 7/048; B23Q 16/00; B23Q 3/00

(57) ABSTRACT

A machine tool system is provided that includes at least one machine tool for machining workpieces. A workpiece holding device is provided that holds one or more workpieces during machining using an adapter. A positioning device positions workpiece blanks on the adapters. An adapter loading and transporting device, which has an adapter gripping device that acts on the adapters and moves adapters that are provided with workpiece blanks from the positioning device to the at least one machine tool, loads the at least one machine tool and unloads adapters that are provided with machined workpieces from the at least one machine tool. A workpiece transporting device is provided which has a workpiece gripping device that acts on workpieces. After machined workpieces have been unloaded by the adapter loading and transporting device, the workpiece transporting device takes the workpieces up from the adapter loading and transporting device and removes them.

This application is a continuation of international application number PCT/EP2015/059817 filed on May 5, 2015 and claims the benefit of German application number 10 2014 106 572.7 filed on May 9, 2014, which are incorporated herein by reference in their entirety and for all purposes.

### BACKGROUND OF THE INVENTION

The invention relates to a machine tool system that comprises at least one machine tool for machining workpieces, having a workpiece holding device, wherein, during workpiece machining, one or more workpieces are held on the workpiece holding device by way of an adapter.

The invention further relates to a method for operating a machine tool system that includes at least one machine tool, wherein, during workpiece machining at the at least one machine tool, one or more workpieces are held on a workpiece holding device by way of an adapter.

With machine tool systems in which workpieces are not held directly on a workpiece holding device of a machine tool but by means of an adapter, it is possible to minimise changeover times when different workpieces are to be machined. By using suitable adapters, the same workpiece holding device may be used without retooling or similar for different workpieces.

DE 10 2008 009 995 A1 discloses a method for transporting workpieces between a plurality of machining points, wherein, at the machining point, a manipulating device clamps the workpieces, by means of a gripping device, and manipulates them. The workpieces remain connected to their gripping device for transport, and both are transported together.

U.S. Pat. No. 4,685,850 discloses a tool and workpiece change system.

### SUMMARY OF THE INVENTION

In accordance with the present invention, a machine tool system is provided, and a method, which has minimized system cycle times.

In accordance with an embodiment of the invention, in the machine tool system a positioning device is provided that positions workpiece blanks on adapters, an adapter loading and transporting device is provided, which has an adapter gripping device that acts on adapters, wherein the adapter loading and transporting device moves adapters that are provided with workpiece blanks from the positioning device to the at least one machine tool, loads the at least one machine tool and unloads adapters that are provided with one or more machined workpieces from the at least one machine tool, and a workpiece transporting device is provided, which has a workpiece gripping device that acts on workpieces, wherein, after machined workpieces have been unloaded at the at least one machine tool by the adapter loading and transporting device, the workpiece transporting device takes them up from the adapter loading and transporting device and removes them.

After unloading of the at least one machine tool by the adapter loading and transporting device, a machined workpiece is transferred to the workpiece transporting device by the “handshake” principle.

Loading the at least one machine tool, and unloading, can be performed effectively. Transferring machined workpieces to the workpiece gripping device can be performed outside the at least one machine tool. In this way, overall system cycle times and tooling times can be minimized.

“Retooling” of the at least one machine tool may be kept to a minimum. As a result, five-axis machining procedures may for example also be performed on the at least one machine tool.

The machine tool system according to the invention is usable and adaptable with flexibility.

It is favourable if the workpiece transporting device takes up machined workpieces from the adapter loading and transporting device outside the at least one machine tool. This allows short system cycle times to be achieved.

In one exemplary embodiment, the adapter gripping device includes at least two grippers. This allows short system cycle times to be achieved. For example, one gripper can hold an adapter that is loaded with one or more workpiece blanks, and the other gripper can hold an “empty” adapter.

In a structurally simple exemplary embodiment, it is provided for the at least two grippers to be connected to one another and to be moved together, at least along one movement axis. Here, the connection may be mechanical, or it may be a software connection in a controller.

It is favourable if a gripper of the adapter gripping device is linearly movable in a first direction and is movable in a second direction transverse to the first direction. Further, linear movability in a third direction transverse to the first direction and transverse to the second direction may be provided. This allows the at least one machine tool to be approached effectively, and the positioning device may be approached. Loading of the at least one machine tool and unloading of the at least one machine tool may be achieved effectively. Further, transfer to the workpiece gripping device may be performed in a simple manner.

In one exemplary embodiment, the first axis is a horizontal direction in relation to the direction of gravity. In this case it is further favourable if the second direction is a vertical direction in relation to the direction of gravity. This allows the machine tool system to be produced simply and compactly.

It is favourable if the workpiece gripping device of the workpiece transporting device includes at least one gripper. This gripper, which acts on a workpiece, can then take up a workpiece from the adapter gripping device effectively and at the same time lift it away from the corresponding adapter.

It is also favourable if the positioning device includes a workpiece gripping device having at least one gripper that acts on workpiece blanks. By way of this at least one gripper, workpiece blanks may for example be taken off a supply belt and deposited on adapters at the positioning device.

It is in particular favourable if a gripper of the workpiece transporting device and/or of the positioning device is linearly displaceable in a first direction and in a second direction transverse to the first direction. This produces a corresponding movability for positioning workpiece blanks on the positioning device, or positioning machined workpieces for example on a removal belt.

It is further favourable if a gripper of the workpiece transporting device and/or of the positioning device is pivotal or rotatable about a first axis of rotation. This enables appropriate orientation or positioning of workpieces (before and/or after machining).

For the same reason, it is favourable if the gripper of the workpiece transporting device and/or of the positioning device is pivotal or rotatable about a second axis of rotation which is different from the first axis of rotation and is in particular oriented transverse thereto. As a result of the rotatability or pivotability about the first axis of rotation and/or the second axis of rotation, a workpiece (a workpiece blank or a machined workpiece) may be gripped and then transported appropriately, and may have the appropriate orientation on being taken off or deposited.

In particular, the adapter gripping device has a first movement axis that lies in the direction of a spacing between the positioning device and the at least one machine tool. This allows adapters that have been loaded with one or more workpieces to be moved from the positioning device to the at least one machine tool. Further, “empty” adapters that have been unloaded by means of the workpiece gripping device of the workpiece transporting device can be supplied to the positioning device again for re-loading.

It is further favourable if the workpiece gripping device of the workpiece transporting device has a second movement axis that lies in the direction of a spacing between the at least one machine tool and a device for removing machined workpieces. This allows machined workpieces to be removed effectively. Further, it allows machined workpieces to be transferred from the adapter loading and transporting device to the workpiece transporting device in a simple manner.

In that case, it is favourable if the second movement axis lies parallel to a first movement axis of the adapter gripping device. This allows the machine tool system according to the invention to be made compact and produced in a structurally favourable manner.

It is most particularly advantageous if the workpiece holding device is configured such that machined workpieces that are positioned on adapters are unclampable from the adapter within the at least one machine tool, and/or workpieces that are positioned on adapters are clampable on adapters within the machine tool. This allows a machine tool system according to the invention to be produced with very little structural complexity. The adapter gripping device or workpiece gripping device can be produced with little structural complexity because there is no need for unclamping of workpieces from adapters, or clamping of workpieces on adapters, to be provided thereon.

It is further favourable if the workpiece gripping device of the workpiece transporting device has a movement space that lies in a movement space of the adapter gripping device in order to transfer machined workpieces from the adapter gripping device to the workpiece gripping device. Overlapping movement spaces allow a workpiece to be transferred by the “handshake” principle in a simple manner.

In one exemplary embodiment, a plurality of machine tools are provided. A plurality of workpieces are machined in the machine tools at the same time, for example, it being possible for fundamentally different machining procedures to be carried out in different machine tools, or like machining procedures, and in particular parallel machining to take place. The adapter loading and transporting device and the workpiece transporting device allow these machine tools to be approached, loaded and unloaded, and machined workpieces to be removed.

It is favourable if a hydraulic system for the machine tools is provided. This hydraulic system serves in particular for clamping and/or releasing workpieces on adapters within machine tools. A common hydraulic system for the machine tools allows the structural complexity to be kept small.

In particular, a common hydraulic unit and in particular a common hydraulic oil reservoir for the machine tools is provided for the plurality of machine tools. This allows the structural complexity to be kept small.

In particular, workpiece holding devices of the machine tools are connected to the hydraulic system. As a result, a workpiece that is clamped on an adapter can be released from the workpiece holding devices within a machine tool, or in one exemplary embodiment a workpiece that is arranged on an adapter may be clamped thereto. As a result, the complexity of releasing or clamping outside the at least one machine tool is reduced.

It is further favourable if a storage device for adapters is provided that holds adapters ready for the positioning device. In this way, effective positioning and in particular also clamping of workpieces on adapters may be performed.

A machine tool system of compact construction may be produced if the storage device is arranged between the positioning device and the at least one machine tool. This also allows the travel paths for the adapter loading and transporting device to be minimized in order for example to hold empty adapters (adapters that are not loaded) ready for the positioning device.

In particular, the storage device is approachable by the adapter loading and transporting device in order to achieve effective transport of loaded and not loaded adapters.

It is favourable if a cleaning device is provided for adapters. In that case, adapters can be cleaned and for example washed after workpiece machining.

In particular, the cleaning device is approachable by the adapter loading and transporting device. This produces short system cycle times.

It is further favourable if a testing device for machined workpieces and/or an ejection device for machined workpieces is provided. This allows for example statistically selected machined workpieces to be tested for defects and where appropriate to be excluded from further processing.

In particular, in this case the testing device and/or the ejection device is/are approachable by the workpiece transporting device. This produces short system cycle times.

In compliance with an embodiment of the invention, a method is provided, said method comprising: gripping an adapter, which is provided with one or more workpiece blanks, by an adapter gripping device; supplying the adapter to the at least one machine tool, by the adapter gripping device; loading the at least one machine tool with the adapter, by the adapter gripping device, and after workpiece machining unloading the at least one machine tool, in that the adapter gripping device grips the adapter; gripping the machined workpiece or workpieces that are seated on the adapter, wherein the adapter is held by the adapter gripping device, by a workpiece gripping device; taking up the workpiece or workpieces from the adapter gripping device; and removing the workpiece or workpieces by means of the workpiece gripping device.

The method according to the invention has the advantages that were already explained in conjunction with the machine tool system according to the invention.

The method according to the invention is performable on the machine tool system according to the invention, and the machine tool system according to the invention can be operated using the method according to the invention.

In particular, the workpiece gripping device takes up the machined workpiece or workpieces outside the at least one machine tool. As a result, the machining procedure that is performable by the at least one machine tool is not constrained by workpiece transport outside the machine tool. For example, five-axis machining procedures are performable by the at least one machine tool.

It is favourable if, after machining within the at least one machine tool, the workpiece or workpieces is/are unclamped from the adapter. This allows the workpiece gripping device and the adapter gripping device to be formed with little structural complexity.

In particular, the workpiece holding device of the at least one machine tool includes a release system for releasing clamping of one or more machined workpieces on an adapter, and/or includes a clamping system for clamping one or more workpieces and in particular workpiece blanks on an adapter. This allows release or clamping to be achieved within the at least one machine tool. In this case, it may be provided for release (unclamping) to take place within the at least one machine tool, and clamping of a workpiece blank on an adapter to take place outside the at least one machine tool, or at a clamping station of a corresponding positioning device.

In particular, on unloading of the at least one machine tool, the machined workpiece or workpieces is/are supported on an adapter. The adapter and the workpiece or workpieces are unclamped from one another, with the adapter itself supporting and hence holding the workpiece. As a result, the adapter gripping device can act on the adapter, and the unclamped workpiece can be released from the adapter and removed and hence taken up, by way of the workpiece gripping device.

It may be provided for the adapter gripping device to have at least a first gripper and a second gripper, wherein at least for part of the time the first gripper holds an empty adapter and the second gripper holds an adapter that is loaded with one or more workpieces. This allows system cycle times to be kept short and travel paths to be kept short.

It is most particularly advantageous if the at least one machine tool is loaded and/or unloaded by the adapter gripping device from above, in relation to the direction of gravity. This allows a loading procedure and an unloading procedure to be performed effectively.

In one exemplary embodiment, a gripper of the adapter gripping device and/or a gripper of the workpiece gripping device is moved in a horizontal direction and a vertical direction, in relation to the direction of gravity. This gives effective transport and effective loading and unloading. It may in particular be provided for a gripper of the adapter gripping device also to be movable in a further horizontal direction and hence to be movable in three linearly independent linear directions.

It is further favourable if a gripper of the workpiece gripping device is rotated or pivoted about at least one axis of rotation. This allows workpieces (in the form of blanks and/or machined workpieces) to be oriented. This results in effective positioning on an adapter, or the transfer from the adapter gripping device to the workpiece gripping device may be achieved in a simple manner.

The description below of preferred embodiments serves, in conjunction with the drawings, to explain the invention in more detail.

### BRIEF DESCRIPTION OF THE DRAWINGS

FIG. 1 shows a schematic plan view of an exemplary embodiment of a machine tool system according to the invention (the direction of gravity g lies perpendicular to the plane of the drawing);

FIG. 2 shows a detail view of the machine tool system according to FIG. 1, in a supply region for workpieces;

FIG. 3 shows a schematic illustration of an exemplary embodiment of a tool holding device of a machine tool of the machine tool system according to FIG. 1, which holds an adapter on which in turn a workpiece is seated;

FIG. 4 shows a detail view of the machine tool system according to FIG. 1, during transfer of a workpiece; and

FIG. 5 shows a schematic illustration of grippers during workpiece transfer after machining of the workpiece.

### DETAILED DESCRIPTION

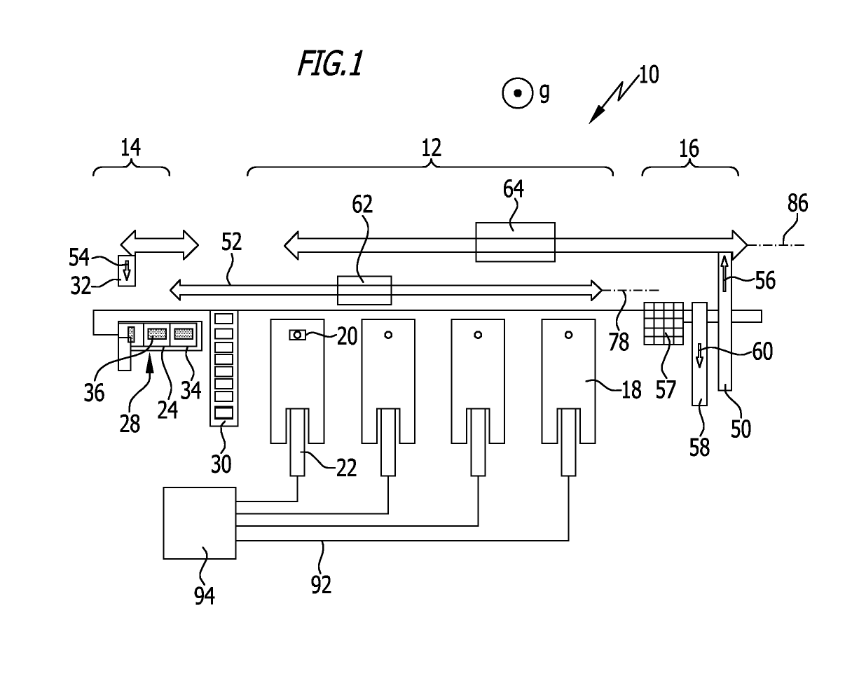

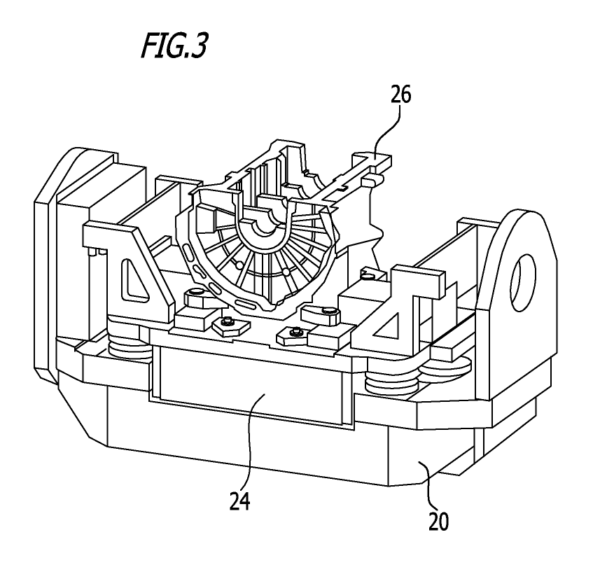

An exemplary embodiment of a machine tool system according to the invention, which is shown in FIGS. 1 to 5 and is designated there by 10, includes a machining region 12, a supply region 14 and a removal region 16. The machining region 12 includes a, and in particular a plurality of, machine tools 18. The machine tools 18 are in particular arranged next to one another. A machine tool 18 includes a workpiece holding device 20 (cf. also FIG. 3) which, during workpiece machining of one or more workpieces, holds the workpiece or workpieces in the machine tool 18. A machine tool 18 further includes a tool carrying device 22, which holds one or more tools during workpiece machining at the corresponding machine tool 18. The tool carrying device 22 includes in particular one or more tool spindles.

Workpiece machining is performed at a machine tool 18, in particular by cutting.

For example, a workpiece that is machined at a machine tool 18 is a metal workpiece.

The machine tools 18 take the form for example of machining centres. Movability of the tool carrying device 22 in relation to the workpiece holding device 20 includes linear axes and one or more pivot axis or axes of rotation. For example, relative movability between a machined workpiece and a tool is produced along five axes.

When workpieces are machined at the respective machine tools, they are held by way of an adapter 24 (cf. FIG. 3) at the corresponding workpiece holding device 20. During workpiece machining, a workpiece 26 is clamped onto the corresponding adapter 24. The adapter 24 is in turn clamped on the workpiece holding device 20. The adapter 24, which takes the form in particular of an adapter plate (palette), makes it possible to fix different workpieces to the workpiece holding device 20 without retooling or exchanging the workpiece holding device 20. An adapter 24 provides an interface between the workpiece 26 and the workpiece holding device 20.

Workpiece blanks for machining are provided to the machining region 12 by way of the supply region 14.

The supply region 14 includes a positioning device 28. At the positioning device 28 workpiece blanks are positioned on adapters 24. In particular, they are also fixed to corresponding adapters 24 at a clamping station there, that is to say they are clamped thereto.

The supply region 14 includes a storage device 30 that holds adapters 24 ready. It is in principle possible for only empty adapters 24, only adapters 24 loaded with workpiece blanks, or both empty adapters 24 and loaded adapters 24 to be held ready at the storage device 30.

In one exemplary embodiment, the supply region 14 is connected to a belt 32 by way of which workpiece blanks are delivered.

It may also be provided for the supply region 14 and in particular the positioning device 28 to include a cleaning device 34. At the cleaning device 34, in particular adapters 24 are cleaned for example by being washed.

It may further be provided for the supply region 14 to include a stamping device 36 which includes for example one or more imprinting units, for example having a needle embosser. At the stamping device 36, a corresponding imprinting unit is used to stamp the relevant machine tool 18 and an adapter number (in particular after a workpiece blank has been fixed to the corresponding adapter 24) into the workpiece.

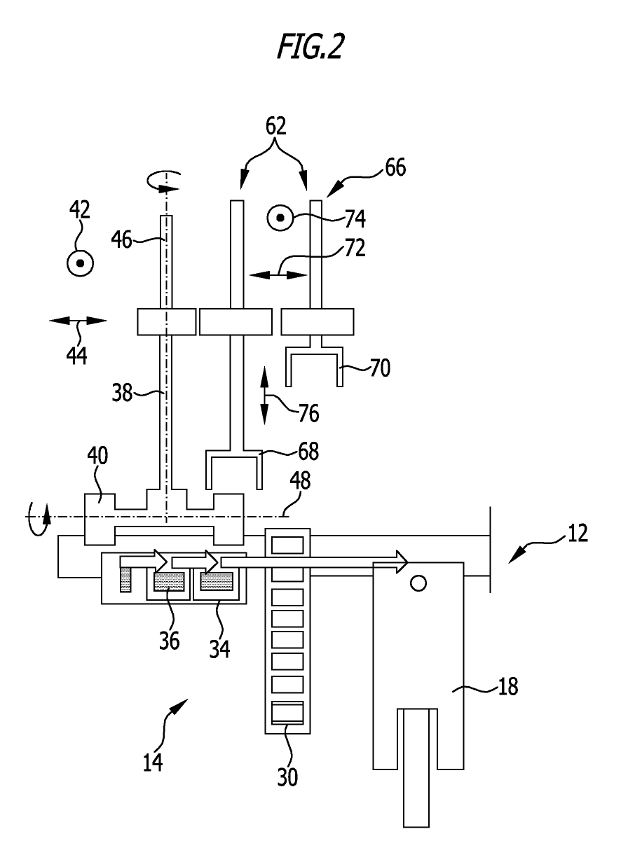

The positioning device 28 includes a workpiece gripping device 38 (FIG. 2). This workpiece gripping device 38 of the positioning device 28 has at least one gripper 40. This gripper 40 is linearly displaceable in a height direction 42 which, in relation to the direction of gravity g (the direction of gravity lies perpendicular to the plane of the drawing in FIG. 2), is in particular a vertical direction. Further, the gripper 40 is displaceable in a linear direction 44 transverse, and in particular perpendicular, to the height direction 42. The linear direction 44 is in particular a horizontal direction in relation to the direction of gravity g.

It may further be provided for the gripper 40 to be rotatable or pivotal about a first axis of rotation 46 (C axis), which lies in particular transverse, and preferably perpendicular, to the height direction 42 and lies transverse, and in particular perpendicular, to the linear direction 44.

In one exemplary embodiment, the gripper 40 is rotatable or pivotal about a second axis of rotation 48 (bucket axis). The second axis of rotation 48 is for example parallel to the linear direction 44.

A workpiece blank may be received from the belt 32 by the gripper (I-shaped gripper) of the workpiece device 38 and placed on an adapter 24 that is held ready, where it is then clamped, in particular to the adapter 24.

For example, the gripper 40 receives a workpiece blank at its end face, performs a pivot about the second axis of rotation 48 and a pivot about the first axis of rotation 46. Then, as described above, the appropriate data are applied to the workpiece blank at the stamping device 36. The workpiece blank is then deposited on the adapter 24 and clamped thereto.

Adapters 24 are held ready by the storage device 30.

The removal region 16 serves for the removal of workpieces that have been machined by the machine tools 18.

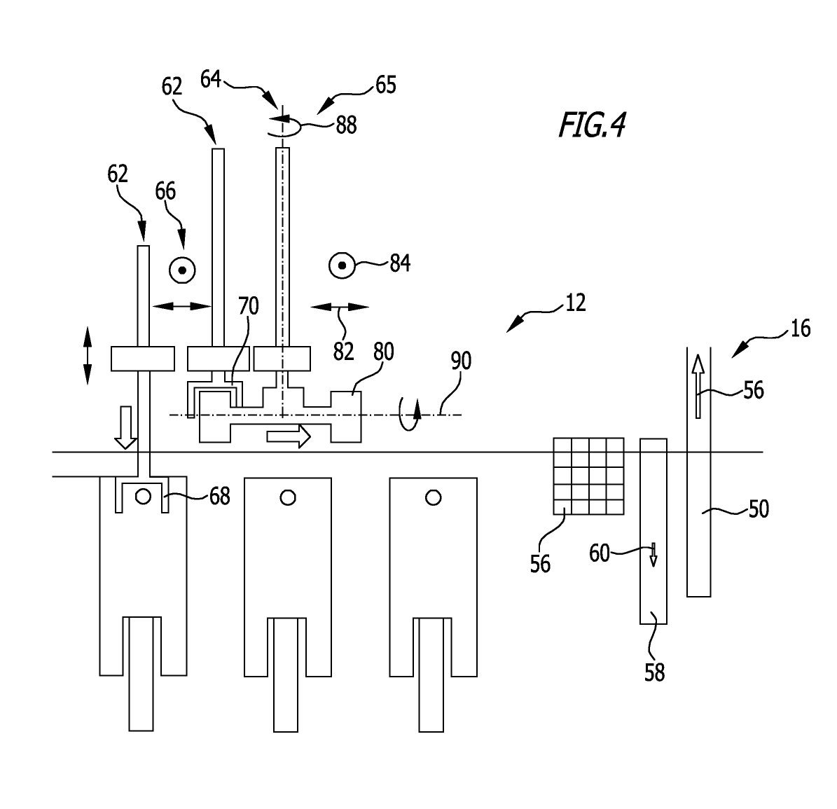

In one exemplary embodiment (FIG. 4), the removal region 16 includes a belt 50 by means of which machined workpieces are removed and in particular are taken to a succeeding machining unit.

In one exemplary embodiment, a main direction of transporting workpieces between the supply region 14, the machining region 12 and the removal region 16 is a linear direction 52 (cf. FIG. 1). This linear direction 52 is in particular parallel to the linear direction 44.

In one exemplary embodiment, a supply direction 54 of the belt 32 lies transverse to the linear direction 52 and in particular perpendicular thereto. This allows the machine tool system 10 to be of compact construction.

A removal direction 56 of the belt 50 lies transverse and in particular perpendicular to the linear direction 52 in order to allow a compact machine tool system 10 to be produced.

It may be provided for a testing device 57, at which machined workpieces are tested, to be arranged in the removal region 16 and thus upstream of the belt 50 for machined workpieces. In this case, it may be provided for each machined workpiece to be tested or for statistically selected workpieces to be tested. Workpieces for which testing showed that they have defects are transferred to an ejector belt 58. In this case, a direction of ejection 60 is in particular transverse and preferably perpendicular to the linear direction 52.

Workpieces that have been tested in the testing device 56 and that “pass” the test are transferred to the belt 50.

The workpiece gripping device 38, which is associated with the positioning device 28, provides for the transport of workpiece blanks between the belt 32 and the positioning device 28. By way of the workpiece gripping device 38, workpiece blanks are deposited on adapters 24 which are held ready, and are clamped there.

For the communication of workpieces between the supply region 14 and the machining region 12, within the machining region 12 and between the machining region 12 and the removal region 16, there is provided an adapter loading and transporting device 62, and a workpiece transporting device 64 is provided. The adapter loading and transporting device 62 includes an adapter gripping device 66 (FIGS. 2, 4), which acts on an adapter 24 and can grasp and hold it.

In one exemplary embodiment, the adapter gripping device 66 has a first gripper 68 and a second gripper 70.

The first gripper 68 and the second gripper 70 are each linearly movable in a first direction 72 and a second direction 74. The second direction 74 lies transverse and in particular perpendicular to the first direction 72. The first direction 72 lies in particular parallel to the linear direction 52.

In one exemplary embodiment, in relation to the direction of gravity g, the first direction 72 is a horizontal direction and the second direction 74 is a vertical direction.

It may further be provided for the first gripper 68 and the second gripper 70 to be movable in a third direction 76. This third direction 76 lies transverse and in particular perpendicular to the first direction 72 and transverse and in particular perpendicular to the second direction 74. The third direction 76 is in particular a horizontal direction, in relation to the direction of gravity g.

In one exemplary embodiment, the first gripper 68 and the second gripper 70 are arranged in a group such that they are mechanically connected to one another for example in relation to movability in the first direction 72 and/or in the second direction 74, or are connected to one another “virtually”, by a corresponding software solution in a controller.

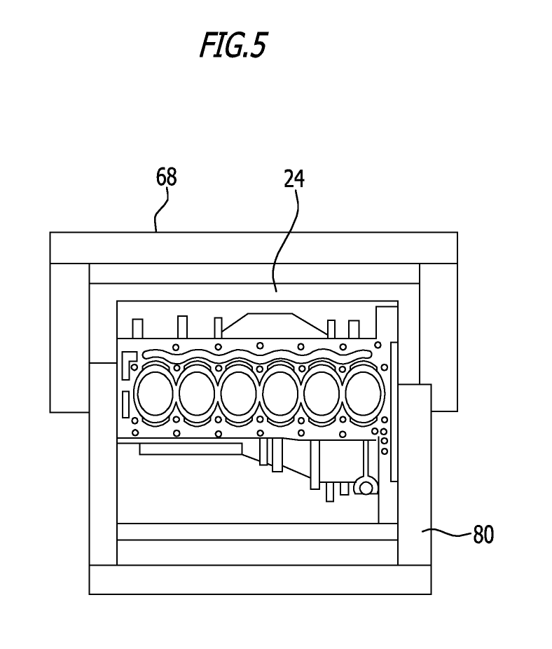

The first gripper 68 and the second gripper 70 are constructed such that they each act on an adapter 24 (see FIG. 5) and not on a workpiece. The first gripper 68 or the second gripper 70 makes contact with and clamps the corresponding adapter 24. It holds it and can transport it.

Workpiece blanks are gripped, by way of the adapter loading and transporting device 62, by the positioning device 28. As mentioned above, the action here is on the corresponding adapter 24 on which the workpiece blank or blanks are arranged.

The adapter 24, together with the workpiece blank or blanks, is then transported to the corresponding machine tool 18 by way of the adapter gripping device 66 along a first movement axis 78, which runs along the direction of the spacing (in the linear direction 52) between the supply region 14 and the machining region 12 and hence in the direction of the spacing between the positioning device 28 and the machine tools 18, which are in particular arranged in a row.

The adapter 24, with the workpiece or workpieces, is then loaded into the corresponding machine tool 18 by the adapter loading and transporting device 62. In particular, loading of the corresponding machine tool 18 takes place from above, in relation to the direction of gravity g. For this, the corresponding gripper 68 or 70, once it has been positioned at the appropriate machine tool 18 by movement in the first direction 72 and at the appropriate height by movement in the second direction 74, moves in the third direction 76 over the corresponding working space. Then, the corresponding gripper 68 or 70, together with the adapter 24 loaded with one or more workpiece blanks, is moved from above towards the workpiece holding device 20. The corresponding adapter 24 is inserted in the workpiece holding device 20 and clamped thereto there.

Once a workpiece has been machined, the corresponding gripper 68 or 70 of the adapter loading and transporting device 62 takes the adapter 24, with the machined workpiece or workpieces, out of the corresponding machine tool 18. For this, once again a gripper 68 or 70, which is now empty, is positioned above the working space of the appropriate machine tool 18 and then moved downwards in the direction 74. The corresponding adapter 24 (with the machined workpiece or workpieces) is received and moved out of the machine tool 18.

Here, it is in particular provided for the machined workpiece or workpieces to be unclamped from the adapter 24 before the adapter 24 is grasped by the corresponding gripper 68 or 70. This unclamping is performed by way of the workpiece holding device 20.

During unloading of the corresponding machine tool 18 by the adapter loading and transporting device 62, the workpiece or workpieces are seated to a certain extent loosely on the adapter 24. The gripper 68 or 70 acts on the adapter 24. The workpiece or workpieces which are seated “loosely” on the adapter 24 are supported by the latter. The adapter 24 still holds the machined workpiece or workpieces, but without clamping them.

In one exemplary embodiment, the workpiece transporting device 64 includes a gripper 80 (I-shaped gripper). This gripper 80 (cf. also FIG. 5) is constructed for gripping (grasping) machined workpieces. It is linearly displaceable in a first direction 82 and in a second direction 84 that is transverse thereto. The second direction 84 is in particular perpendicular to the first direction 82.

In one exemplary embodiment, in relation to the direction of gravity g, the first direction 82 is a horizontal direction and the second direction 84 is a vertical direction.

The first direction 82 is in particular parallel to the linear direction 52. As a result of the movability in the first direction 82, a second movement axis 86 is defined for the workpiece transporting device 64. This second movement axis 86 is in particular parallel to the first movement axis 78 of the adapter loading and transporting device 62.

In one exemplary embodiment, the gripper 80 is rotatable or pivotal about a first axis of rotation 88, which in particular lies transverse and preferably perpendicular to the first direction 82 and the second direction 84.

Further, the gripper 80 is pivotal or rotatable about a second axis of rotation 90. The second axis of rotation 90 in particular forms a bucket axis. The second axis of rotation 90 in particular lies parallel to the first direction 82.

It may also be provided for the gripper 80 to be linearly displaceable in a third direction perpendicular to the first direction 82 and perpendicular to the second direction 84. With an appropriate construction of the adapter loading and transporting device 62, there is no need to provide displaceability of this kind in the third direction.

The gripper 80 is in principle constructed in the same way as the gripper 40 of the workpiece gripping device 38, and in one exemplary embodiment has the same patterns of movement.

The workpiece transporting device 64 serves to transport workpieces from the machining region 12 to the removal region 16. The adapter gripping device 66 of the adapter loading and transporting device 62, and the gripper 80 of the workpiece transporting device 64, have overlapping areas of movement. The workpiece transporting device 64 is constructed such that it can take off workpieces that have been provided by the adapter gripping device 66 outside the machine tools 18, and can provide them to the removal region 16 by a corresponding displacement and where appropriate orientation by way of rotation about the first axis of rotation 88 and/or the second axis of rotation 90.

The adapter gripping device 66 provides an adapter 24 having seated thereon one or more machined workpieces, which have been released. The gripper 80 of the workpiece transporting device 64 then grasps the corresponding machined workpiece or workpieces (cf. FIG. 5). Removal from the adapter 24 is then performed. Removal is performed by a movement of the gripper 80 relative to the corresponding gripper 68 or 70 that holds the adapter. The gripper 80, which holds the machined workpiece, then supplies the latter to the removal region 16. The corresponding adapter gripping device 66 holds, by means of the first gripper 68 or the second gripper 70, an “empty”, i.e. not loaded, adapter. The latter is then provided to the supply region 14 by a corresponding displacement of the first gripper 68 or the second gripper 70. There, cleaning is performed at the cleaning device 34 (where necessary), and this “empty” adapter 24 can be loaded with a workpiece blank again.

In one exemplary embodiment, the machine tools 18 of the machining region 12 have a hydraulic system 92 that serves in particular to release workpieces from adapters 24 within the machine tools 18 if the corresponding adapter 24 has not yet been clamped on the respective workpiece holding device 20. This hydraulic system 92 in particular includes a common hydraulic unit 94 having a corresponding hydraulic oil reservoir, by way of which a plurality of machine tools 18 are operated.

A “central” hydraulic unit 94 of this kind allows a compact machine tool system 10 to be produced.

The machine tool system 10 according to the invention is operated as follows:

At the positioning device 28, one or more workpiece blanks are positioned and in particular also fixed on corresponding adapters 24 by way of the workpiece gripping device 38. For this purpose, the positioning device 28 includes a corresponding clamping station. As a result of appropriate movability of the gripper 40, in addition to the positioning it is also possible to perform a corresponding orientation relative to a condition in which workpiece blanks are supplied by way of the belt 32.

The adapter gripping device 36 takes up, by way of a gripper (for example) the gripper 70, a “clamped” adapter 24, that is to say it takes up an adapter 24 on which one or more workpieces are clamped. The other gripper, for example the first gripper 68, holds an “empty” adapter, which is deposited at the positioning device 28 after the loaded adapter has been received. This “empty” adapter is cleaned at the cleaning device 34 before being loaded with a workpiece blank.

After machining of the workpiece or workpieces at the corresponding machine tool 18, the adapter gripping device 66 fetches the corresponding adapter 24 with the machined workpiece or workpieces from the corresponding machine tool 18. During this, the machined workpiece or workpieces are unclamped from the adapter 24 if the adapter 24 is still seated in the corresponding workpiece holding device 20 of the corresponding machine tool 18. When the adapter 24, with the unclamped workpiece, is taken out, the adapter 24 supports the workpiece and still holds it, albeit unclamped.

Outside the corresponding machine tool 18, the adapter gripping device 66 holds the machined workpiece or workpieces, which are still arranged on the corresponding adapter 24, ready for the workpiece transporting device with its workpiece gripping device 65 having the gripper 80. The gripper 80 acts on the machined workpiece or workpieces. As a result of a corresponding relative movement between the gripper 80 and the corresponding gripper of the adapter gripping device 66, the machined workpiece or workpieces are taken off the adapter 24. During this, the workpiece or workpieces are held on the gripper 80, and a corresponding movement provides the machined workpiece or workpieces to the removal region 16.

The corresponding gripper of the adapter gripping device 66 now holds an adapter 24 which is not loaded, and which is provided to the positioning device 28 again by a corresponding travelling movement.

Five-axis machining, for example, is performed on the machine tools 18.

The machined workpieces are for example cylinder crankcases.

The solution according to the invention provides a flexible interface for the transfer of workpieces. Short system cycle times may be achieved, and losses due to setup times are minimisable. The orientation (by way of the workpiece gripping device 38 of the positioning device 28) and the clamping of workpiece blanks on adapters 24 are performed separated from the machining region 12. The transfer of workpieces between the adapter loading and transporting device 62 and the workpiece transporting device 64 is performed by the “handshake” principle. This allows short system cycle times to be achieved. Furthermore, the number of adapters 24 required can be kept small. In principle, there is no need for a large-scale retooling of the machine tools 18. An appropriate construction of the workpiece holding device 20 is sufficient for example in the case of the exemplary embodiment, in which unclamping of workpieces from adapters 24 is performed within machine tools 18 at the corresponding workpiece holding device 20.

The use of adapters 24 allows the system to be adapted flexibly to different workpiece types.

For the construction of the grippers 68, 70, 80 and 40, it is possible to make use of existing industry solutions.

As regards the system cycle time, loading and unloading of the machine tools 18 is the most critical aspect. The use of at least two grippers 68, 70 allows short system cycle times to be achieved. Typically, it is sufficient to provide only a single gripper 80, since the transfer of machined workpieces from the adapter gripping device 66 to the workpiece gripping device 65 has less relevance for system cycle times.

### LIST OF REFERENCE NUMERALS

10 Machine tool system
12 Machining region
14 Supply region
16 Removal region
18 Machine tool
20 Workpiece holding device
22 Tool carrying device
24 Adapter
26 Workpiece
28 Positioning device
30 Storage device
32 Belt
34 Cleaning device
36 Stamping device
38 Workpiece gripping device
40 Gripper
42 Height direction
44 Linear direction
46 First axis of rotation
48 Second axis of rotation
50 Belt
52 Linear direction
54 Supply direction
56 Removal direction
57 Testing device
58 Ejector belt
60 Direction of ejection
62 Adapter loading and transporting device
64 Workpiece transporting device
65 Workpiece gripping device of the workpiece transporting device
66 Adapter gripping device
68 First gripper
70 Second gripper
72 First direction
74 Second direction
76 Third direction
78 First movement axis
80 Gripper
82 First direction
84 Second direction
86 Second movement axis
88 First axis of rotation
90 Second axis of rotation
92 Hydraulic system
94 Hydraulic unit

What is claimed is:

1. A machine tool system, comprising:
at least one machine tool for machining workpieces, having a workpiece holding device, wherein, during workpiece machining, one or more workpieces are held on the workpiece holding device by way of an adapter;
a positioning device that positions workpiece blanks on adapters;
an adapter loading and transporting device, having an adapter gripping device that acts on adapters, wherein the adapter loading and transporting device moves adapters that are provided with workpiece blanks from the positioning device to the at least one machine tool, loads the at least one machine tool and unloads adapters that are provided with one or more machined workpieces from the at least one machine tool; and
a workpiece transporting device, having a workpiece gripping device that acts on workpieces, wherein, after machined workpieces have been unloaded at the at least one machine tool by the adapter loading and transporting device, the workpiece transporting device takes them up from the adapter loading and transporting device and removes them.

2. A machine tool system according to claim 1, wherein the workpiece transporting device takes up machined workpieces from the adapter loading and transporting device outside the at least one machine tool.

3. A machine tool system according to claim 1, wherein the adapter gripping device includes at least two grippers.

4. A machine tool system according to claim 3, wherein the at least two grippers are connected to one another and moved together.

5. A machine tool system according to claim 1, wherein a gripper of the adapter gripping device is linearly movable in a first direction and is movable in a second direction transverse to the first direction.

6. A machine tool system according to claim 5, wherein the first direction is a horizontal direction, in relation to the direction of gravity.

7. A machine tool system according to claim 5, wherein the second direction is a vertical direction, in relation to the direction of gravity.

8. A machine tool system according to claim 1, wherein the workpiece gripping device of the workpiece transporting device includes at least one gripper.

9. A machine tool system according to claim 1, wherein the positioning device includes a workpiece gripping device having at least one gripper that acts on workpiece blanks.

10. A machine tool system according to claim 8, wherein a gripper of at least one of the workpiece transporting device and the positioning device is linearly displaceable in a first direction and in a second direction transverse to the first direction.

11. A machine tool system according to claim 8, wherein a gripper of at least one of the workpiece transporting device and the positioning device is pivotal or rotatable about a first axis of rotation.

12. A machine tool system according to claim 11, wherein the gripper of at least one of the workpiece transporting device and the positioning device is pivotal or rotatable about a second axis of rotation which is different from the first axis of rotation.

13. A machine tool system according to claim 1, wherein the adapter gripping device has a first movement axis that lies in the direction of a spacing between the positioning device and the at least one machine tool.

14. A machine tool system according to claim 1, wherein the workpiece gripping device of the workpiece transporting device has a second movement axis that lies in the direction of a spacing between the at least one machine tool and a device for removing machined workpieces.

15. A machine tool system according to claim 14, wherein the second movement axis lies parallel to a first movement axis of the adapter gripping device.

16. A machine tool system according to claim 1, wherein the workpiece holding device is configured such that at least one of (i) machined workpieces that are positioned on adapters are unclampable from the adapter within the at least one machine tool and (ii) workpieces that are positioned on adapters are clampable on the adapters within the machine tool.

17. A machine tool system according to claim 1, wherein the workpiece gripping device of the workpiece transporting device has a movement space that lies in a movement space of the adapter gripping device, in order to transfer machined workpieces from the adapter gripping device to the workpiece gripping device.

18. A machine tool system according to claim 1, comprising a plurality of machine tools.

19. A machine tool system according to claim 18, comprising a hydraulic system for the machine tools.

20. A machine tool system according to claim 19, comprising a common hydraulic unit for the machine tools.

21. A machine tool system according to claim 19, wherein workpiece holding devices of the machine tools are connected to the hydraulic system.

22. A machine tool system according to claim 1, comprising a storage device for adapters that holds adapters ready for the positioning device.

23. A machine tool system according to claim 22, wherein the storage device is arranged between the positioning device and the at least one machine tool.

24. A machine tool system according to claim 23, wherein the storage device is approachable by the adapter loading and transporting device.

25. A machine tool system according to claim 1, comprising a cleaning device for adapters.

26. A machine tool system according to claim 25, wherein the cleaning device is approachable by the adapter loading and transporting device.

27. A machine tool system according to claim 1, comprising at least one of a testing device for machined workpieces and an ejection device for machined workpieces.

28. A machine tool system according to claim 27, wherein at least one of the testing device and the ejection device is approachable by the workpiece transporting device.

29. A method for operating a machine tool system that includes at least one machine tool, wherein, during workpiece machining at the at least one machine tool, one or more workpieces are held on a workpiece holding device by way of an adapter, comprising:
gripping an adapter, which is provided with one or more workpiece blanks, by an adapter gripping device;
supplying the adapter to the at least one machine tool, by the adapter gripping device;
loading the at least one machine tool with the adapter, by the adapter gripping device, and after workpiece machining unloading the at least one machine tool, in that the adapter gripping device grips the adapter;
gripping the machined workpiece or workpieces that are seated on the adapter, wherein the adapter is held by the adapter gripping device, by a workpiece gripping device;
taking up the workpiece or workpieces from the adapter gripping device; and
removing the workpiece or workpieces by means of the workpiece gripping device.

30. A method according to claim 29, wherein the workpiece gripping device takes up the machined workpiece or workpieces outside the at least one machine tool.

31. A method according to claim 29, wherein, after machining within the at least one machine tool, the workpiece or workpieces is/are unclamped from the adapter.

32. A method according to claim 29, wherein the workpiece holding device comprises at least one of a release system for releasing clamping of one or more machined workpieces on an adapter, and a clamping system for clamping one or more workpieces and in particular workpiece blanks on an adapter.

33. A method according to claim 29, wherein, on unloading of the at least one machine tool, the machined workpiece or workpieces is/are supported on the adapter.

34. A method according to claim 29, wherein the adapter gripping device has at least a first gripper and a second gripper, wherein at least for part of the time the first gripper holds an empty adapter and the second gripper holds an adapter that is loaded with one or more workpieces.

35. A method according to claim 29, wherein the at least one machine tool is at least one of loaded and unloaded by the adapter gripping device from above, in relation to the direction of gravity.

36. A method according to claim 29, wherein at least one of a gripper of the adapter gripping device and a gripper of the workpiece gripping device is moved in a horizontal direction and a vertical direction, in relation to the direction of gravity.

37. A method according to claim 29, wherein a gripper of the workpiece gripping device is rotated or pivoted about at least one axis of rotation.
